(19) United States
(12) Patent Application Publication
(10) Pub. No.: US 2014/0009294 A1
(43) Pub. Date: Jan. 9, 2014

(54) Snooze alert

(71) Applicants: Edmund M. Martinez, Las Vegas, NV (US); Darrell T. Harness, Las Vegas, NV (US); Edmund P. Martinez, Las Vegas, NV (US)

(72) Inventors: Edmund M. Martinez, Las Vegas, NV (US); Darrell T. Harness, Las Vegas, NV (US); Edmund P. Martinez, Las Vegas, NV (US)

(21) Appl. No.: 13/507,531

(22) Filed: Jul. 6, 2012

(51) Int. Cl. G08B 21/06

(52) U.S. Cl. 340/575

(57) ABSTRACT

The Snooze Alert is a device that prevents a person from falling asleep while driving a vehicle, truck, buss or for any reason that requires a person to stay awake and alert. The advantage of this device is that it does not hang on the ear and it has three sources of power. The Snooze Alert is incased in a soft pouch with an adjustable strap that holds the pouch between the lower chin and the upper chest area. When a person's head tilts forward or to the side, like when falling asleep the chin depresses the activator switch which send an electrical current that activates the vibrator and the buzzer and thereby instantly waking up the person.

The Snooze Alert is a device with only one purpose: to keep a person awake and alert when driving a car, bus, truck or an airline flight controller or whoever is required to stay awake and alert. The Snooze Alert is incased in a pouch that is placed between the lower chin and the upper chest area with an adjustable straps to hold the device in place. The difference from other alerts is that it does not hang on the ear and it has three different sources of power; two rechargeable AA batteries, incased in the battery container (22), an attachment for a vehicle twelve volt system and a 110 volt adaptor (24), when used with the 110 volt reducer, which also will charge the batteries. All the elements are attached to the base (20), with an oblong cutaway at the lower section of the base. The battery container is glued to the top section of the base and is equipped with an on and off switch. The activator (26) which is the automatic switch is glued to the top lid of the container. The vibrator (30) fits loosely on the cutaway section, held in place by two upper straps (32) and two bottom straps (32A) with Velcro at the ends to secure the vibrator. The buzzer (28) is attached to the bottom of the base. The foam rubber cushion (34) is glued to the bottom of the base to cushion the upper chest area. When the Snooze Alert is in position and the head tilts forward of the side, like when falling asleep, the chin depresses the activator which instantly delivers an electrical current to the buzzer and the vibrator simultaneously creating a loud noise and rattling the sensitive chest area and instantly awakening the person. When the head returns to the normal position, the activator stops the electrical current to the buzzer and vibrator.

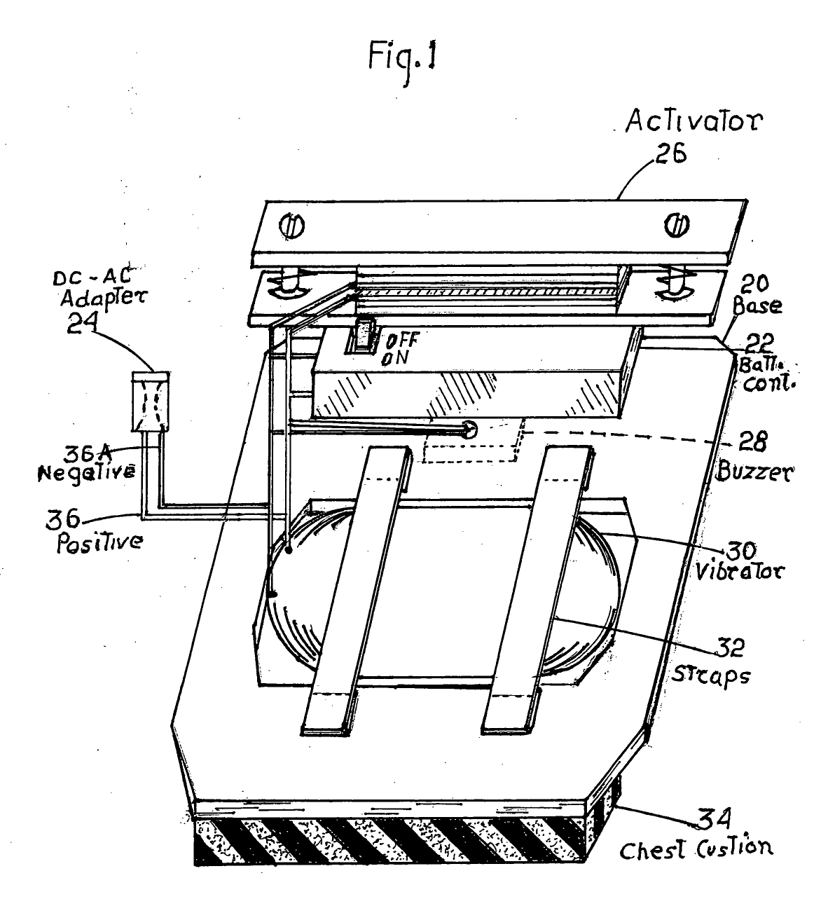

Descriptions to accompany submitted drawings, FIGS. 1 through 7:

FIG. 1 shows the embodiment of the Snooze Alert, displaying a perspective view of one version of the top of the Snooze Alert. The base (20) holds all of the components. The batteries and container (22), sends an electrical current through the positive and negative wiring, (36 & 36A) to the Activator (26). When compressed, it activates the vibrator (30) and the buzzer (28), until the pressure is released from the activator. The connection for direct current (DC) is supplied by an alternating current (AC) adaptor (24). The two straps (32) hold the vibrator (30) in place. The chest cushion (36) provides comfort to the user.

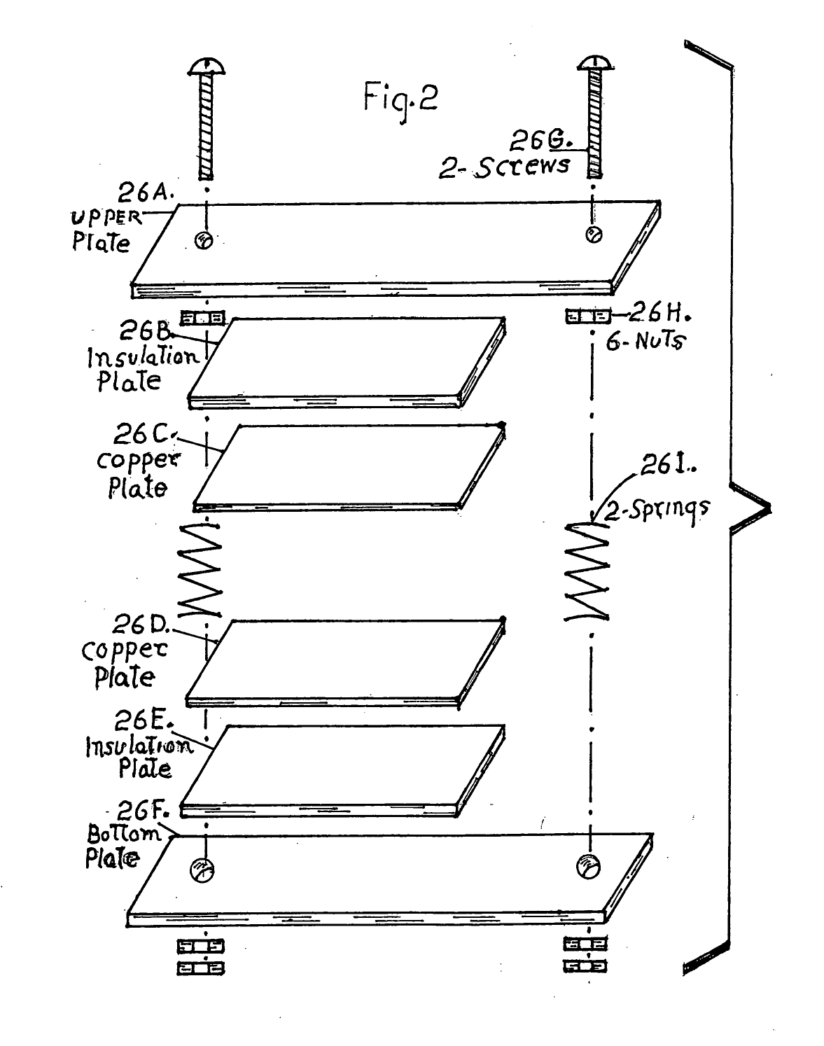

FIG. 2 shows an exploded view of the Activator (26). The upper plate (26A) is an aluminum plate, followed by the insulation plate (26B), two copper plates (26C & 26 D), another insulation plate (26E) and the bottom aluminum plate (26F). The two copper plates are separated by two springs (26I).

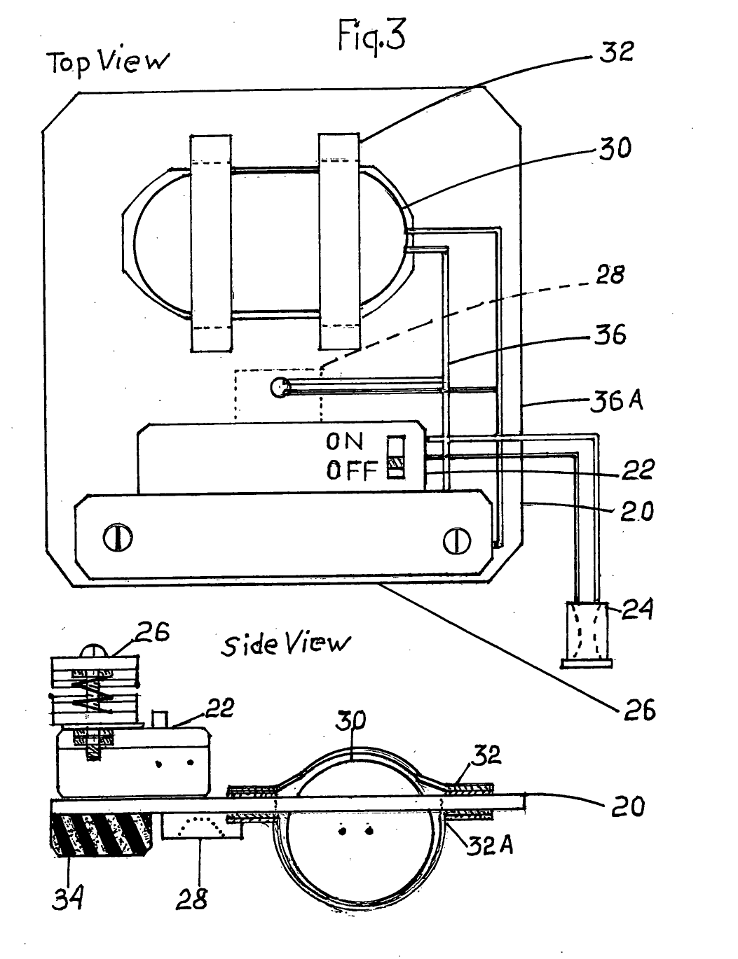

FIG. 3 shows a top and side view of the Snooze Alert. The top view view displays the base (20), the battery container (22), the AC adaptor (24), the activator (26), the vibrator (30) and the two upper straps (32). The side view shows the base (20), the battery container (22), the activator (26). The buzzer (28), the vibrator (30), the two upper straps (32), the two lower straps (32A) and the chest cushion (34).

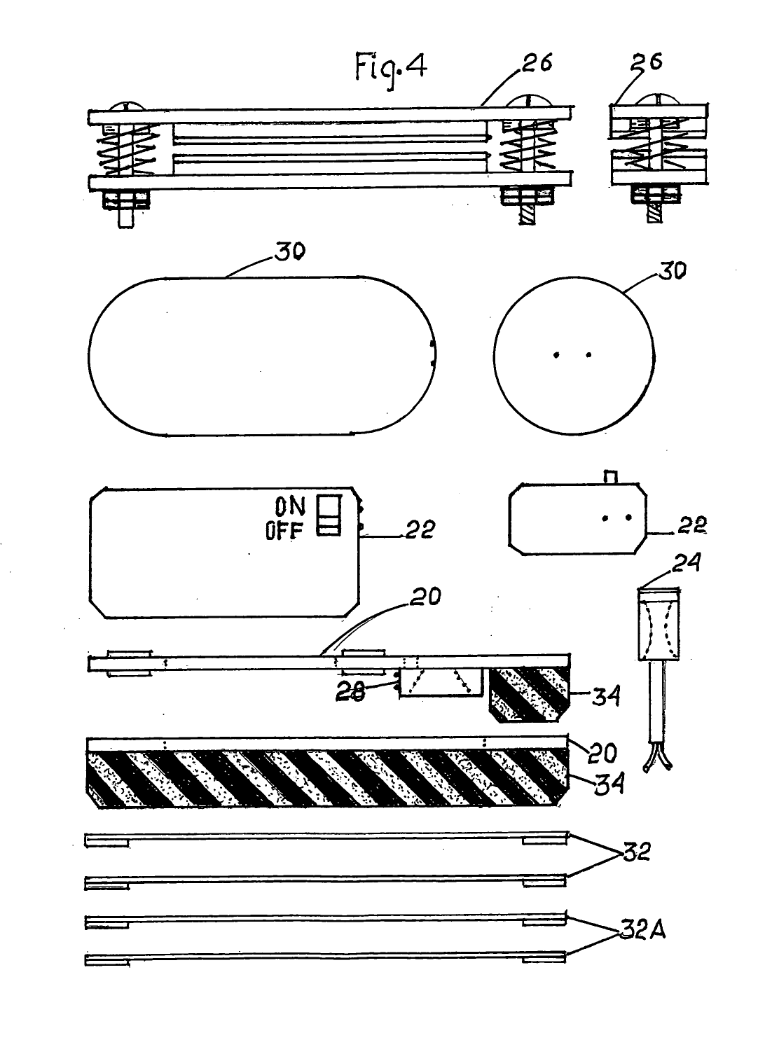

FIG. 4 shows the side and end views of the activator (26), the vibrator (30), battery container (22), the base (20), the buzzer (28), the chest cushion (34) the AC adaptor (24) and the two upper and lower straps (32 & 32A).

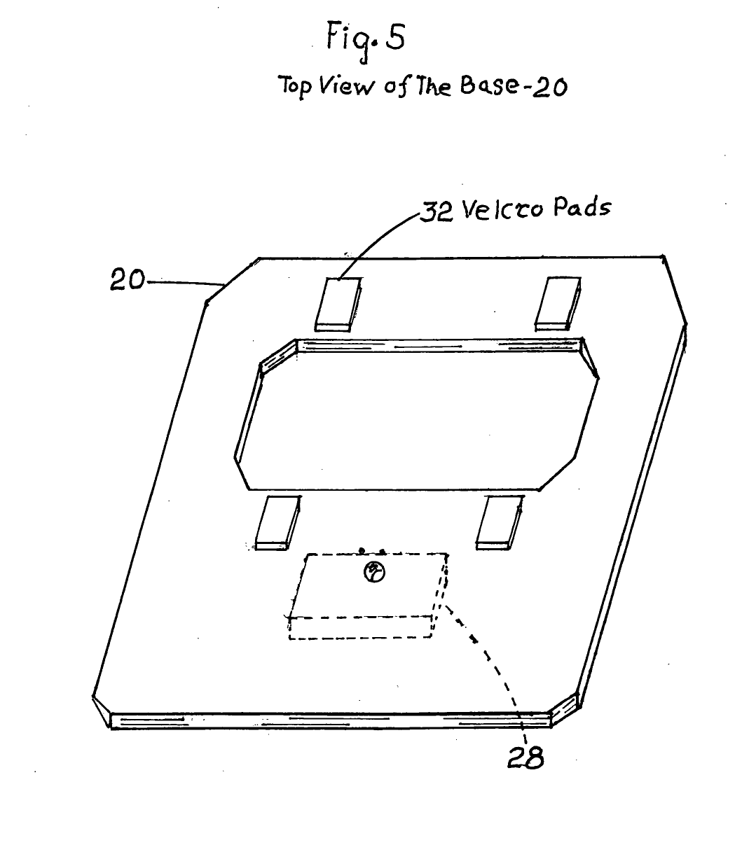

FIG. 5 shows a perspective view of the top of the base (20), four Velcro pads that the straps (32) attach to and the position of the buzzer (28).

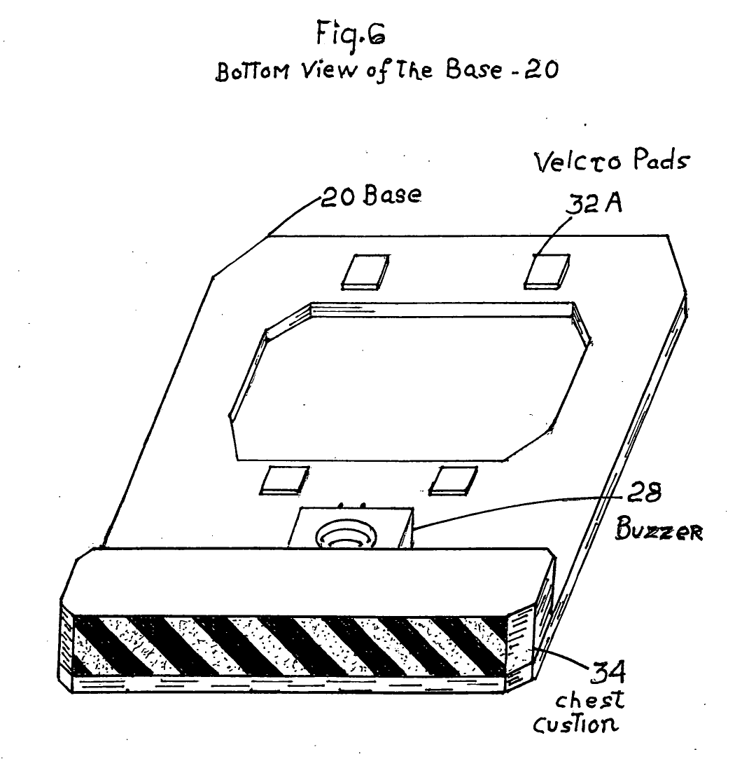

FIG. 6 shows a perspective view of the bottom of the base (20), four Velcro pads that the straps (32A) attach to, the buzzer (22) and the chest cushion (34).

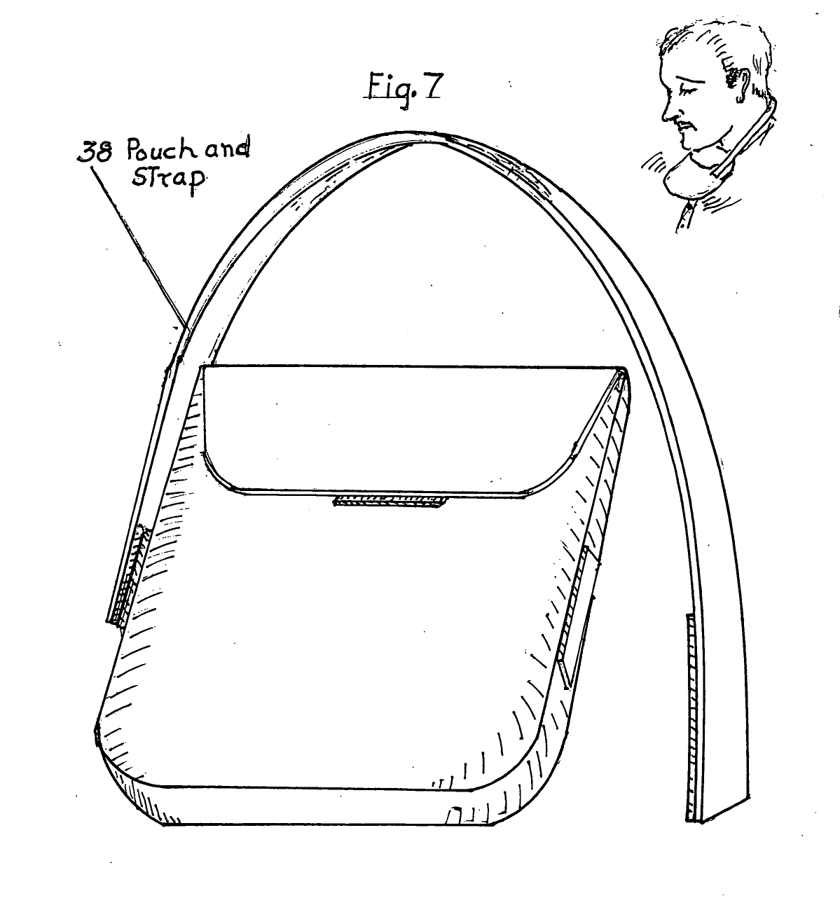

FIG. 7 shows the pouch and adjustable neck strap which houses the Snooze Alert.

1. A perspective view of one version of the snooze alert. The said alert has an advantage over other alerts, as it does not hang on the ear. My device is incased in a soft terry cloth pouch, with an adjustable neck strap (35) and it is placed between the lower chin and upper chest area.
1. The base (20) holds all the elements of said Snooze Alert.
2. The battery container (22) is glued to the top of the base (20).
3. The activator (26) is glued to the lid of the battery container (22).
4. The vibrator (30) fits in the cutaway hole of the base (20) and is held in place by two upper straps (32) and two bottom straps (32A).
5. The AC/DC jack (24) is connected to the positive (36) and to the negative (36A).
6. The buzzer (28) is located underneath the base (20) and is connected to the positive and negative terminals.
When a person has the Snooze Alert in place and the head tilts forward like when falling asleep, the chin touches the activator (26) and that releases an electrical current to the vibrator (30) and simultaneously to the buzzer (28), which immediately awakens the person. When the head returns to a normal position, it releases the pressure to the activator (30) and stops the flow of current to the buzzer and vibrator.
The Activator (26) is the automatic switch that controls and distributes the flow of current to the vibrator (30) and the buzzer (28). The Activator is located on top of the battery container at the upper section of the base (20). The elements of the Activator are; the upper aluminum plate (A), the perfboard insulation plate (B), the copper plate (C), the bottom copper plate (D), the bottom insulation perfboard plate (E), the bottom aluminum plate (F), two machine screws (G), six nuts (H) and two coil springs (I).
A top and side view of the elements of the Snooze Alert:
1. The top view of the base (20) displaying the positive wiring (36), the negative wiring (36A) connecting to all the elements
2. The top view of the battery container with an off and on switch (22) that sends the electrical power to the activator (26), which distributes the current to the vibrator (30) and the buzzer (28).
3. The side view also displaying the base (20), the battery container (22), the activator (26), the vibrator (30) and the buzzer (28).
4. The upper straps (32), the bottom straps (32A) hold the vibrator in place.
5. The side view of the upper chest cushion (34), cushions the upper chest area.
